(19) United States
(12) Patent Application Publication
(10) Pub. No.: US 2006/0208200 A1
(43) Pub. Date: Sep. 21, 2006

(54) Microscope and detector module

(75) Inventor: Roland Seifert, Kassel (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems CMS GmbH, Wetzlar (DE)

(21) Appl. No.: 11/359,836

(22) Filed: Feb. 22, 2006

Related U.S. Application Data
(60) Provisional application No. 60/758,765, filed on Jan. 13, 2006.

(30) Foreign Application Priority Data
Feb. 23, 2005 (DE) DE 102005008619.5

(51) Int. Cl. G01J 1/58

(52) U.S. Cl. 250/458.1

(57) ABSTRACT

A microscope includes a light source and a detector device. An illumination beam path extends between the light source and a sample. A detection beam path extends between the sample and the detector device. The detector device includes a detector module insertable into the detection beam path and configured to be replaced as a unit.

Priority is claimed to the provisional application entitled “Microscope and Detector Module,” filed by applicant on Jan. 13, 2006, and to German patent application DE 10 2005 008 619.5, filed on Feb. 23, 2005, the entire subject matters of both of which are hereby incorporated by reference herein.

The present invention relates to a microscope having a light source and a detector device, an illumination beam path extending between the light source and a sample, and a detection beam path extending between the sample and the detector device. The present invention also relates to a detector module, in particular for use in a microscope.

### BACKGROUND

Microscopes that have a light source and a detector device exist in a variety of forms well-known in the field. If it is desired to detect at least two spectral regions of the detection beam separately and preferably simultaneously, a selection of the spectral regions is required. To this end, the detection light beam must be spectrally dispersed, and the respective spectral regions need to be separated out toward the individual detectors. In this context, the term “separate out” is understood to mean that a component beam including the first spectral region is able to pass through the means that are used, on the one hand, to separate out the first spectral region and, on the other hand, to reflect at least part of the spectral region that is not separated out, while at least one component beam including a second spectral region is reflected, etc. With regard to the published prior art, reference is made to German Patent DE 43 30 347 C2, in which a so-called multi-band detector for simultaneous detection of a plurality of spectral regions of a detection light beam is described along with its practical application.

However, the microscopes described in the prior art and the multi-band detectors used therein are problematic in practice because the independent arrangement of the individual components requires considerable adjustment effort. Moreover, the multi-band detectors known heretofore are not very flexible in their application, since these multi-band detectors have a fixed configuration in terms of the individual detectors and other components thereof.

### SUMMARY OF THE INVENTION

It is an object of the present invention, therefore, to provide a microscope having a light source and a detector device which operates in accordance with the multi-band principle, in a way that will make possible a flexible use and simple handling while entailing a relatively low adjustment effort.

The present invention provides a microscope having a light source and a detector device, an illumination beam path extending between the light source and a sample, and a detection beam path extending between the sample and the detector device. The detection device is designed as a detector module which is insertable into the detection beam path and able to be replaced in whole, i.e., as a unit.

The present invention is based on the realization that the adjustment effort should be limited to a module that is pre-adjusted within itself, namely by designing the detector device as a detector module which is insertable into the detection beam path and able to be replaced in whole. This detector module can be handled as such, so that it is only necessary to ensure that the detector module as a whole is correctly positioned in the detection beam path and appropriately adjusted. There is no need to adjust individual optical components or individual subassemblies. The detector module can be handled as such and itself already includes all optical components of a multi-band detector known from the prior art in an adjusted configuration.

With regard to the flexibility of the detector module, it is advantageous if said detector module includes at least two independent detectors, and if these two detectors can be replaced together or separately. This means that the detector module can be replaced by itself, i.e. as a whole together with the detectors, while the individual detectors can also be replaced by themselves. The detector module may include a plurality of individual detectors, for example, 3 to 5 independent detectors, said detectors being able to be replaced together or separately.

For purposes of easy attachment of the individual detectors, a detector location is provided in the detector module for each detector. Thus, each detector location of the detector module can be occupied by a detector or by a dummy element, but in case a detector location is not occupied by a detector, it is mandatory to occlude the otherwise clear optical path with the aid of the dummy element and, possibly, a suitable integral mirror system, or the like.

In order to provide functionality similar to that of the multi-band detector known in the prior art, the detector module can includes detectors of the same type. In order to provide a variable design, it is possible to equip the detector module with different detector types, for example, with photomultiplier tubes, photon counters, etc. Any combinations of detector types may be conceived of, according to the requirements; the housings of the respective detectors being designed to be compatible, namely in order to provide uniform attachment to the detector module.

With regard to the coupling-in of the detection light, it is advantageous if the detection light is split into color components before it enters the detection module. To this end, an optical means for dispersing or splitting the detection light may be provided upstream of the point at which the detection light is coupled into the detector module. The dispersed detection light beam or the split detection light beams then enter the detector module together, where they are relayed—in a further split form—to the respective detectors according to the specific design of said detectors. The optical means for dispersing or splitting the detection light may be a prism.

As mentioned earlier, the whole detector module is inserted into the detection beam path of the microscope and fixedly disposed therein. To this end, special coupling means are provided; these coupling means being associated, on the one hand, with the detector module itself and, on the other hand, with a housing of the microscope and/or one or more subassemblies of the microscope. The detector module is arranged such that is accessible and replaceable from outside the housing of the microscope, which eliminates the need to further interfere with the insides of the microscope.

The coupling means may specifically be a push-fit connection or a bayonet connection; the joining techniques used being combined joining techniques, with or without latching action and, in particular, also with an integral adjustment capability.

In addition to the mechanical coupling, electronic connections are advantageously provided which are preferably connected concurrently with the mechanical coupling, i.e., when the detector module is inserted. The electrical connections include electrical conductors for power supply and for data transmission.

From a design standpoint, and in particular to allow the detector module to be easily handled and accommodated, it is advantageous for the detector module to include a receiving block in the form of a drum for the individual detectors. The individual detectors are arranged along the circumference of the drum, so that the resulting geometry allows splitting of the light beam from the center of the drum to the radially outwardly disposed detectors. The receiving block forming the drum may preferably be made of aluminum.

The receiving block is kind of a housing which forms an interior space. This interior space is at least largely closed off from the outside, except for the connection openings for the optical path of the detection light, which are needed for the coupling to the detection beam path, on the one hand, and for the attachment of the individual detectors, on the other hand.

In accordance with the above explanations, the housing forming the drum, i.e. the receiving block, is provided with bays along its circumference, said bays being used for attachment of the individual detectors. Each of these bays has an opening for the detection light that is diverted from the interior space of the housing to the respective detector, the opening being used for insertion of a mounting flange of the respective detector. Accordingly, the individual detector is adapted, in terms of its housing, to the receiving block bay used for attachment and to the opening provided therein for feeding in the detection light. In accordance with this embodiment, the housings of all detectors are identical in design, independently of the detector type provided therein.

The individual detectors can be push-fitted to the receiving block (in the respective bays), and, in addition, are capable of being locked in position. Thus, it is possible, for example, to screw the individual detectors, in their positions, to the housing of the receiving block, namely in order to ensure reliable positioning of the individual detectors, so that misalignment of the detectors is difficult or impossible in this respect.

As has been mentioned earlier, the detection light beam is split before it enters the receiving block. The already split detection light passes through an input port in the receiving block and into the interior space of the receiving block, where it hits a beam splitter device for further splitting the detection light to the individual detectors. The beam splitter device may include a system of cascaded mirror slides. It is also conceivable for the beam splitter device, in particular for the optical components thereof, to be associated in whole or in part with the detectors to be inserted, or with the dummy elements to be inserted in place of one or more detectors. Thus, the individual detectors and/or the dummy elements replacing the detectors may form part of the beam splitter device.

Also advantageously, the detector module includes electronic functional elements or functional units. The same may apply to the detectors to be attached. The electronic functional elements or functional units are used for signal processing and may take the form of, for example, an A/D converter. Any miniaturizable functional units may be integrated into the detector module or the individual detectors.

The detector module and/or the individual detectors usually contain heat-generating components, such as detector tubes. The operating temperature reached by such components during operation is so high that proper operation is no longer guaranteed, especially in the case of an encapsulated design. Thus, it is advantageous if the detector module and/or the individual detectors has/have a cooling device for cooling the heat-generating components. To this end, a Peltier element may be used which thermally connects the detector module and/or the detectors to the microscope housing or to the microscope stand.

Specifically, the cooling device could include an inner heat exchanger associated with the heat-generating component and an outer heat exchanger associated with the housing of the detector module or with the housing or stand of the microscope; the heat exchangers being in fluid communication with each other. For example, the cooling device could be designed as a water cooling system, or, quite generally, as a refrigerant cooling system having a refrigerant line. The refrigerant line, in turn, may be a conventional line for refrigerants, or else a heat pipe.

The present invention also provides a detector module, in particular for use in a microscope as described above according to the present invention. The microscope has a light source, an illumination beam path extending between the light source and a sample, and a detection beam path extending between the sample and the detector module. The detector module is insertable into the detection beam path and able to be replaced in whole. To avoid repetitions, reference is made to the explanations regarding the microscope of the present invention.

### BRIEF DESCRIPTION OF THE DRAWINGS

The teaching of the present invention can be embodied and refined in different ways. The present invention is elaborated upon below based on an exemplary embodiment with reference to the drawings. In the drawings:

FIG. 1 is a schematic view of an exemplary embodiment of an inventive detector module in the detection beam path of a microscope according to the present invention;

FIG. 2 is a schematic view of the subject-matter of FIG. 1, showing three of the individual detectors uncoupled from the detector module;

FIG. 3 is a schematic, partially sectional side view of the detector module of FIGS. 1 and 2, illustrating the attachment of an individual detector and the path of the split detection light;

FIG. 4 is an enlarged cross-sectional view of an individual detector which is capable of being coupled to the detector module; and

FIG. 5 shows a subassembly of the detector of FIG. 4, including a detector tube and other functional elements.

### DETAILED DESCRIPION

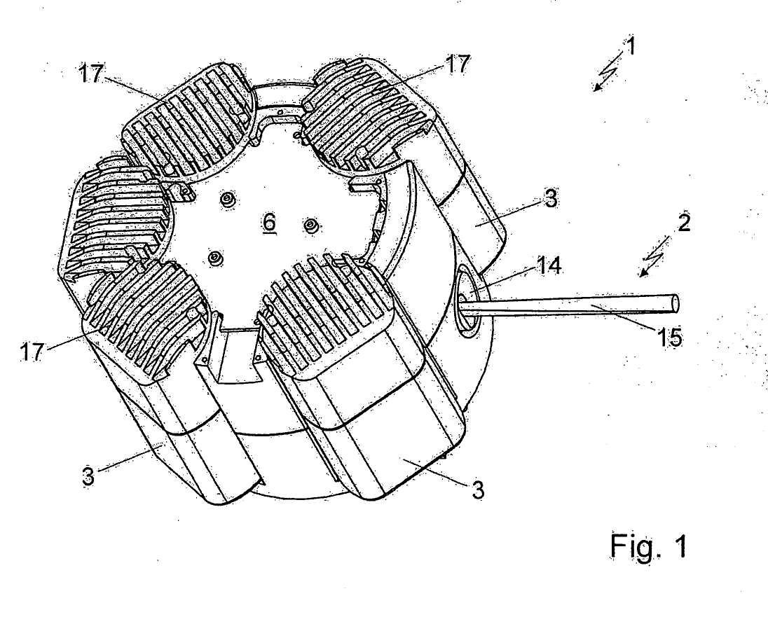

FIG. 1 schematically shows an inventive detector module 1, which forms part of a microscope according to the present invention. With regard to the microscope, only detection beam path 2 is shown with the detection light being already split. Detector module 1 is disposed in detection beam path 2 of the otherwise not shown microscope.

In accordance with the present invention, detector module 1 is a replaceable component which can be handled by itself, i.e. as such. The individual components parts of detector module 1 are adjusted such that the detector module needs only to be inserted into the detection beam path 2 and to be adjusted therein as a whole.

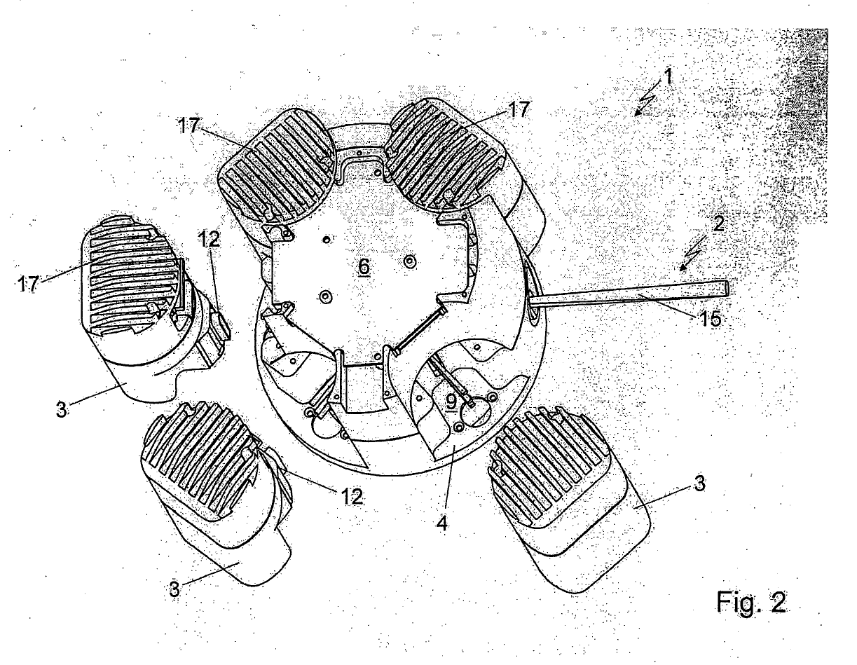

FIGS. 1, 2 and 3 together show that, in the exemplary embodiment chosen here, detector module 1 includes a total of five detectors 3 which are independent of each other and which, in turn, can be replaced together or separately. This is indicated in FIG. 2.

Detector module 1 has provided therein a separate detector location 4 for each detector 3, it being possible for each detector location 4 of detector module 1 to be occupied by a detector 3 or by a dummy element (not shown in the Figures). As has been explained in detail above, detectors 3 may be detectors of different types. In this regard, reference is made to the explanations given in the general description.

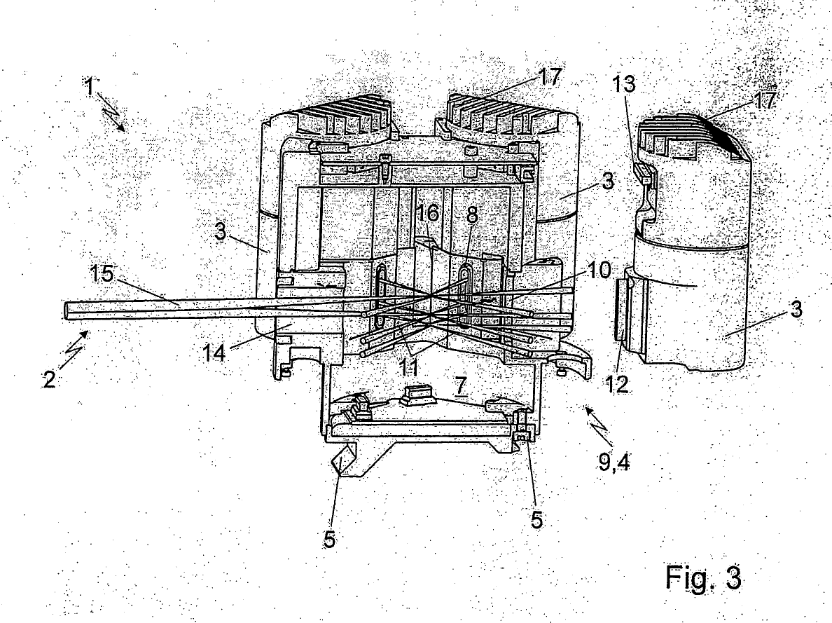

Detector module 1 is capable of being inserted into detection beam path 2 or, more specifically, into a corresponding housing part of the microscope, using mechanical and electrical coupling means 5. Mechanical and electrical coupling means 5 are indicated in FIG. 3.

Ultimately, said coupling means include a push-fit connection or a bayonet connection, as well as electrical connections for power supply and for data transmission.

In FIGS. 1 through 3, it can further be seen that detector module 1 essentially includes a receiving block 6 designed along the lines of a drum. Detectors 3 are arranged along the circumference of receiving block 6, said receiving block 6 forming a housing having an interior space 7 which is closed off from the outside, except for the connection openings 8 for the optical path of the detection light.

For purposes of attachment of detectors 3, bays 9 are formed in receiving block 6 along the circumference thereof, said bays 9 having outwardly directed openings 10 for the detection light 11 that is diverted from interior space 7 of housing 6 to the respective detector 3. Openings 10 are formed and sized such that they allow insertion of a mounting flange 12 of the respective detector 3. In this manner, an optical connection is provided.

As can be seen in FIGS. 3, 4 and 5, each detector 3 further has a plug 13 used for mechanical and/or electrical connection.

As mentioned earlier, the individual detectors 3 can be push-fitted to the receiving block 6 and locked in position. This is accomplished using screws.

Receiving block 6 includes an input port 14 for the already split detection light beam 15, and further includes a beam splitter device 16 which is associated with interior space 7 of receiving block 6 and which, in turn, includes cascaded mirror slides.

In FIGS. 3, 4 and 5, the structure of a detector 3, which can be modularly push-fitted to detector module 1 according to the requirements, is shown in whole or in part. For example, it can be seen in FIG. 3 that, in addition to mounting flange 12 for optical coupling, detector 3 includes a plug 13 for electrical coupling; both mounting flange 12 and plug 13 also being used for mechanical coupling. In order to cool heat-generating elements of detector 3, said detector is provided on the outside with cooling fins 17, namely which generate the waste heat and which are disposed inside the detector housing 18 in a more or less encapsulated form.

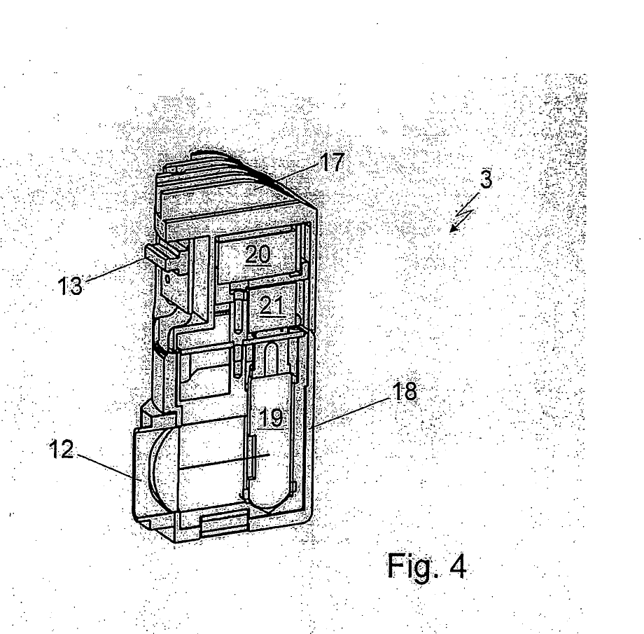

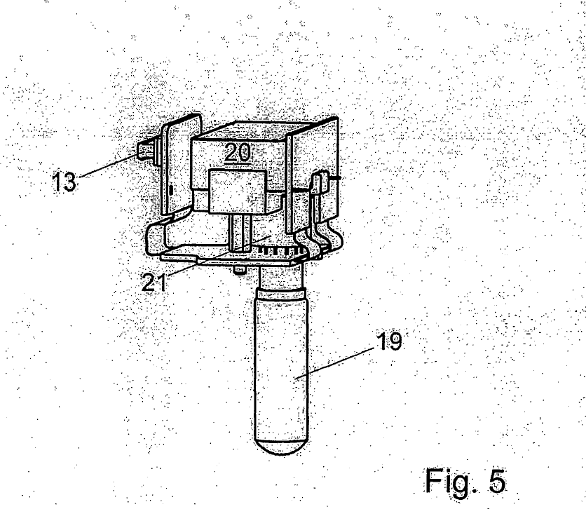

In addition to detector housing 18 and cooling fins 17, FIGS. 4 and 5 show plug 13, which is used for electrical connection, and mounting flange 12, which is used for optical connection. Also shown is detector tube 19, together with power supply 20 and cooling head 21.

With regard to other features which cannot be seen in the Figures, and to avoid repetitions, reference is made to the general part of the description. Besides, it should be noted that the exemplary embodiment discussed above serves merely for illustrative discussion of the claimed teaching without limiting it to the exemplary embodiment.

What is claimed is:

1. A microscope comprising:
a light source, an illumination beam path extending between the light source and a sample; and
a detector device, a detection beam path extending between the sample and the detector device, the detector device including a detector module insertable into the detection beam path and configured to be replaced in whole.

2. The microscope as recited in claim 1 wherein the detector module includes a plurality of independent detectors replaceable together or separately.

3. The microscope as recited in claim 1 wherein the detector module includes three to five independent detectors replaceable together or separately.

4. The microscope as recited in claim 1 wherein:
the detector module includes a plurality of independent detectors;
the detector module includes a respective detector location for each of the detectors; and
each respective detector location is configured to receive one of the detectors or a dummy element.

5. The microscope as recited in claim 1 wherein the detector module includes a plurality of detectors of the same or different types.

6. The microscope as recited in claim 5 wherein each of the detectors includes a tube detector.

7. The microscope as recited in claim 6 wherein the tube detector includes at least one of a photomultiplier tube and a photon counter.

8. The microscope as recited in claim 1 further comprising an optical splitting device disposed in the detection beam path upstream of a location at which detection light is coupled into the detector module and configured to disperse or split the detection light.

9. The microscope as recited in claim 8 wherein the optical splitting device includes a prism.

10. The microscope as recited in claim 1 wherein the detector module is configured to be inserted into the detection beam path using a coupling device associated with the detector module and with at least one of a housing of the microscope and a subassembly of the microscope.

11. The microscope as recited in claim 10 wherein the detector module is configured to be accessible and replaceable from outside the housing of the microscope.

12. The microscope as recited in claim 10 wherein the coupling device includes a push-fit connection.

13. The microscope as recited in claim 10 wherein the coupling device includes a bayonet connection.

14. The microscope as recited in claim 10 wherein the coupling device includes electrical connections for power supply and for data transmission.

15. The microscope as recited in claim 1 wherein the detector module includes a plurality of individual detectors and a receiving block configured to receive the individual detectors.

16. The microscope as recited in claim 15 wherein the receiving block has a form of a drum.

17. The microscope as recited in claim 15 wherein the receiving block includes aluminum.

18. The microscope as recited in claim 15 wherein the receiving block includes a housing having an interior space substantially closed off from an outside except for connection openings for an optical path of detection light.

19. The microscope as recited in claim 18 wherein the housing includes a plurality of bays along a circumference thereof, the bays each configured for attachment of a respective one of the individual detectors, the bays each including a respective opening for detection light diverted from the interior space of the housing to the respective one of the detectors, each of the detectors including a respective mounting flange configured to be received into the respective opening.

20. The microscope as recited in claim 19 wherein each of the individual detectors is configured to be push-fitted to the receiving block and locked into a respective position.

21. The microscope as recited in claim 20 wherein each of the individual detectors is configured to be locked in the respective position by a respective screw connection.

22. The microscope as recited in claim 15 wherein the receiving block includes an input port for a detection light beam, and includes a beam splitter device configured to split a detection light beam to the individual detectors.

23. The microscope as recited in claim 22 further comprising an upstream beam splitter device configured to split detection light upstream of the receiving block so as to provide the detection light beam.

24. The microscope as recited in claim 22 wherein the beam splitter device includes a plurality of cascaded mirror slides.

25. The microscope as recited in claim 22 wherein optical components of the beam splitter device are at least in part each respectively associated with the individual detectors or with dummy elements insertable in place of one or more of the detectors.

26. The microscope as recited in claim 1 wherein the detector module includes a plurality of electronic functional units.

27. The microscope as recited in claim 26 wherein the electronic functional units are configured for signal processing.

28. The microscope as recited in claim 27 wherein the electronic functional units include an A/D converter.

29. The microscope as recited in claim 1 wherein the detector module includes a cooling device configured to cool a heat-generating component.

30. The microscope as recited in claim 29 wherein the cooling device includes a Peltier element configured to thermally connect the detector module to a housing of the microscope or to a stand of the microscope.

31. The microscope as recited in claim 1 wherein the detector module includes a plurality of individual detectors, each of the individual detectors including a respective cooling device configured to cool a respective heat-generating component.

32. The microscope as recited in claim 31 wherein each of the respective cooling devices includes a respective Peltier element configured to thermally connect the respective individual detector to a housing of the microscope or to a stand of the microscope.

33. The microscope as recited in claim 29 wherein the cooling device includes an inner heat exchanger associated with the heat-generating component and an outer heat exchanger associated with at least one of a housing of the detector module, a housing of the microscope and a stand of the microscope, the inner and outer heat exchangers being in fluid communication with each other.

34. The microscope as recited in claim 33 wherein the cooling device includes a water cooling system.

35. The microscope as recited in claim 33 wherein the cooling device includes a refrigerant cooling system having a refrigerant line.

36. The microscope as recited in claim 35 wherein the refrigerant line includes a heat pipe.

37. The microscope as recited in claim 31 wherein each of the detectors are encapsulated by a respective housing including a respective heat-conducting element configured to connect a respective heat-generating component to respective cooling fins disposed on an outside of the respective housing.

38. A detector module for a microscope having a light source, an illumination beam path extending between the light source and a sample, the detector module comprising a plurality of detectors and being insertable into a detection beam path extending between the sample and the detector device, wherein the plurality of detectors are configured to be replaced by a replacing of the detector module in whole.
